(19) United States
(12) Patent Application Publication
(10) Pub. No.: US 2011/0320241 A1
(43) Pub. Date: Dec. 29, 2011

(54) SYSTEMS AND METHODS FOR EVALUATING PERFORMANCE OF AFTERMARKET VEHICLE PART SALES

(75) Inventor: Gerald Martin Miller, Cumming, GA (US)

(73) Assignee: Experian Information Solutions, Inc., Costa Mesa, CA (US)

(21) Appl. No.: 12/881,130

(22) Filed: Sep. 13, 2010

Related U.S. Application Data
(63) Continuation of application No. 12/826,425, filed on Jun. 29, 2010, now abandoned.

(51) Int. Cl. G06Q 10/00

(52) U.S. Cl. 705/7.31

(57) ABSTRACT

A system and method for evaluating the performance of aftermarket vehicle part sales for assortment planning, the method including: receiving a vehicle part identifier associated with a vehicle part to be evaluated, receiving information related to vehicles in operation in a given market, receiving product information related to the vehicle part, receiving sales information related to the vehicle part in the given market, processing the information related to vehicles in operation in a given market, the product information related to the vehicle part and the sales information related to the vehicle part to produce an evaluation of the aftermarket performance of the vehicle part sales, and generating an evaluation report of the aftermarket performance of the vehicle part sales.

### CROSS-REFERENCE TO RELATED APPLICATIONS

This application is a continuation of U.S. application Ser. No. 12/826,425, filed Jun. 29, 2010 and titled SYSTEMS AND METHODS FOR EVALUATING PERFORMANCE OF AFTERMARKET VEHICLE PART SALES, the disclosure of which is hereby incorporated by reference in its entirety into this application.

### BACKGROUND

1. Field of the Disclosure

This disclosure relates generally to automated vehicle analysis systems for evaluating the performance of vehicle part sales in the aftermarket.

2. Description of the Related Art

Operators in the vehicle aftermarket industry would like to increase their efficiency by better managing their product portfolio and their inventory levels. The operators would also like to better assess locations for future retail stores, service bays and distribution centers. These goals can be made more achievable by giving the operators a timely and accurate view of the aftermarket for vehicle parts in various ways, including geographic, vehicle type specific and vehicle age specific.

### SUMMARY

This disclosure provides systems and methods for evaluating performance of aftermarket vehicle part sales.

In one embodiment, a method of evaluating the aftermarket performance of vehicle part sales is disclosed. The method includes: receiving a vehicle part identifier associated with a vehicle part to be evaluated, receiving information related to vehicles in operation in a given market, receiving product information related to the vehicle part, receiving sales information related to the vehicle part in the given market, processing the information related to vehicles in operation in a given market, the product information related to the vehicle part and the sales information related to the vehicle part to produce an evaluation of the aftermarket performance of the vehicle part sales, and generating an evaluation report of the aftermarket performance of the vehicle part sales.

In another embodiment, a system for evaluating the aftermarket performance of vehicle part sales is disclosed. The system includes: a computer system having a processor that supports operation of a software application, a data storage module, in communication with the computer system, the data storage module including information about vehicles in operation in a given market, product information related to the vehicle part and sales information related to the vehicle part in the given market, an aftermarket vehicle part sales evaluation module configured to evaluate the aftermarket sales performance of the plurality of vehicle part data records, and an output module for reporting the vehicle part sales evaluation to a user, wherein the computer system is configured to accept a vehicle part identifier and to communicate the vehicle part identifier to the aftermarket vehicle part sales evaluation module, and wherein the aftermarket vehicle part sales evaluation module bases its evaluation of aftermarket vehicle part sales on at least the vehicle part identifier, the information about vehicles in operation in a given market, the product information related to the vehicle part and the sales information related to the vehicle part in the given market.

### BRIEF DESCRIPTION OF THE DRAWINGS

An architecture that implements the various features of the disclosure will now be described with reference to the drawings. The drawings and the associated descriptions are provided to illustrate embodiments of the disclosure and not to limit its scope. Throughout the drawings, reference numbers are reused to indicate correspondence between referenced elements.

FIG. 1 illustrates a block diagram of an embodiment of a system for evaluating aftermarket vehicle part sales.

FIG. 2 illustrates a flow diagram of an embodiment of an aftermarket vehicle part sales evaluation method.

FIG. 3 illustrates an exemplary aftermarket vehicle part sales evaluation report.

FIG. 4 illustrates an exemplary sales performance report.

### DETAILED DESCRIPTION

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions described herein.

In one embodiment, an aftermarket vehicle part sales evaluation system receives data from one or more databases that store vehicle information, and processes the information to determine performance of vehicle part sales in the aftermarket. While some of this disclosure refers to the systems with respect to automobiles, it is understood that the same or similar systems could be configured to provide similar information for any type of vehicle, including motorcycles, bicycles, sailboats, power boats, ships, airplanes, jets, recreational vehicles, ATVs, and the like. Reports of the various aftermarket evaluations over geographic areas can be generated to help vehicle dealerships, manufacturers, and the like plan and execute marketing strategies.

An illustrative example will provide useful context in understanding the systems and methods disclosed herein. In this example, information in various databases about two vehicle parts in an analyzed product line, oil filters TG2 and TG16, in a geographic area (such as Houston, Tex. for example) includes the following:
Total Vehicles in Operation in Houston, Tex.: 4,768,956
Total Vehicles in Operation in Houston, Tex. which can be equipped with an oil filter of the product line analyzed: 3,878,118
Total Vehicles in Operation in Houston, Tex. which can be equipped with the TG2: 520,658 vehicles
Total Retail Unit Volume of oil filters in this product line during given period: 58,178 units
Total Retail Dollar Volume of oil filters in this product line during given period: $359,854
Total Retail Unit Volume of all oil filters in this market during given period: 321,811 units
Total Retail Dollar Volume of all oil filters in this market during given period: $359,854
Total Retail Unit Volume of the TG2 in Houston, Tex. during given period: 7,270 units
Retail Average Price of the TG2 in Houston, Tex.: $6.23
Total Retail Dollar Volume of the TG2 in Houston, Tex.: $45,299
Total Vehicles in Operation in Houston, Tex. which can be equipped with the TG16: 298,500 vehicles
Total Retail Unit Volume of the TG16 in Houston, Tex.: 5,490 units
Retail Average Price of the TG16 in Houston, Tex.: $6.13
Total Retail Dollar Volume of the TG16 in Houston, Tex.: $33,638

The aftermarket vehicle part sales evaluation system processes this information to generate a report which indicates, for example:
Of the vehicles in operation which can be equipped with an oil filter, share of vehicles which can be equipped with a TG2: 13.4%
Of the vehicles in operation which can be equipped with an oil filter, share of vehicles which can be equipped with a TG16: 7.7%
Sales Rate for the TG2: 1.4%
Sales Rate for the TG16: 1.8%
Share of Total Retail Product Unit Volume for the TG2: 2.3%
Share of Total Retail Product Dollar Volume for the TG2: 2.2%
Share of Total Retail Product Unit Volume for the TG16: 1.7%
Share of Total Retail Product Dollar Volume for the TG16: 1.6%

This type of information allows operators in the vehicle aftermarket industry to increase their efficiency by better managing their product portfolio and their inventory levels. The operators may also better assess locations for future retail stores, service bays and distribution centers.

Various embodiments and examples of the systems and methods for evaluating the aftermarket sales performance of vehicle parts will now be described with reference to the drawings. Like numbers indicate corresponding parts among the drawings and the leading digit represents the figure in which such part was first shown. Computing System

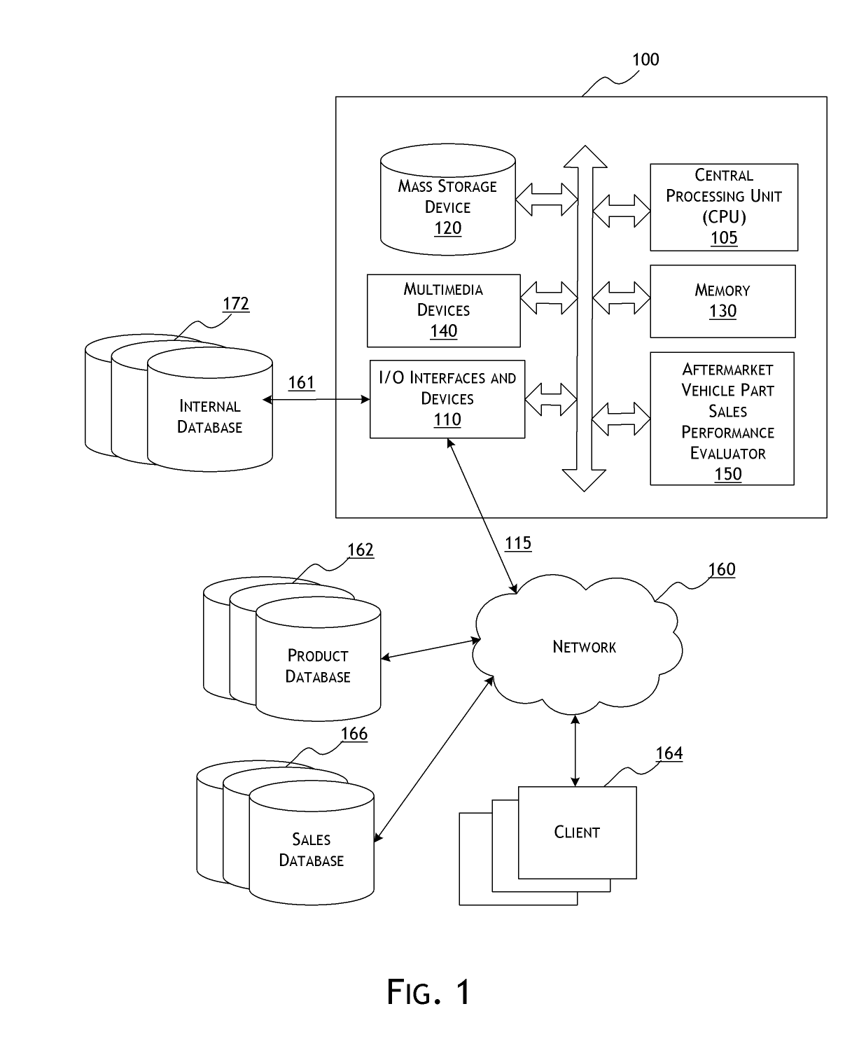

In some embodiments, the systems, computer clients and/or servers described above take the form of a computing system as shown in FIG. 1. FIG. 1 is a block diagram showing an embodiment in which computing system 100 is in communication with a network 160 and various systems are also in communication with the network 160. The computing system 100 may be used to implement systems and methods described herein. For example, the computing system 100 may be configured to receive vehicle information from various databases and generate an evaluation of aftermarket vehicle part sales. In some embodiments, the system is accessed remotely by the client, the system is local to the client, and/or a combination of the two. Example clients may be vehicle parts manufacturers, vehicle parts retailers, vehicle insurance providers or lenders that use the systems and methods to evaluate the performance of aftermarket sales of different vehicle parts in a given geographic area.

Although the description provided herein refers to individuals, consumers, or customers, the terms “individual,” “consumer,” and “customer” should be interpreted to include applicants, or groups of individuals or customers, such as, for example, organizations, groups, and business entities.

The computing system 100 includes, for example, a personal computer that is IBM, Macintosh, or Linux/Unix compatible. In one embodiment, the computing system 100 comprises a server, a laptop computer, a cell phone, a personal digital assistant, a kiosk, or an audio player, for example. In one embodiment, the exemplary computing system 100 includes a central processing unit (“CPU”) 105, which may include a conventional microprocessor. The computing system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the computing system 100 are connected to the computer using a standard based bus system. In different embodiments, the standard based bus system could be Peripheral Component Interconnect (“PCP”), Microchannel, Small Computer System Interface (“SCSI”), Industrial Standard Architecture (“ISA”) and Extended ISA (“EISA”) architectures, for example. In addition, the functionality provided for in the components and modules of computing system 100 may be combined into fewer components and modules or further separated into additional components and modules.

The computing system 100 is generally controlled and coordinated by operating system software, such as Windows 95, Windows 98, Windows NT, Windows 2000, Windows XP, Windows Vista, Unix, Linux, SunOS, Solaris, or other compatible operating systems. In Macintosh systems, the operating system may be any available operating system, such as MAC OS X. In other embodiments, the computing system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 100 includes one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The computing system 100 may also include one or more multimedia devices 140, such as speakers, video cards, graphics accelerators, and microphones, for example.

In the embodiment of FIG. 1, the I/O devices and interfaces 110 provide a communication interface to various external devices. In the embodiment of FIG. 1, the computing system 100 is electronically coupled to a network 160, which comprises one or more of a LAN, WAN, or the Internet, for example, via a wired, wireless, or combination of wired and wireless, communication link 115. The network 160 communicates with various computing devices and/or other electronic devices via wired or wireless communication links.

According to FIG. 1, information is provided to computing system 100 over the network 160 from one or more data sources including, for example, product databases 162, sales databases 166 and/or client consumer data. The information supplied by the various data sources may include vehicle product data, vehicle sales data, for example. In some embodiments, product databases 162 may include information regarding which vehicles may be equipped with a given vehicle part. In some embodiments, sales databases 166 may include information regarding sales of vehicle parts by part number and geographic region for all major retailers of vehicle parts, such as AutoZone, PepBoys, NAPA, O'Reilly, and the like. In addition to the devices that are illustrated in FIG. 1, the network 160 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

A client 164 may supply data and/or request information from the computing system 100. For example, the client 164 may request data related to a specific vehicle part in a given geographic market. Such a request may include product information identifying the product(s) for which information is desired.

The I/O devices and interfaces 110 further provide a communication interface to an internal database 172. The internal database 172 may comprise information about vehicles in operation, for example. In one embodiment, information about vehicles in operation provides fact-based information about vehicles currently on the road. In one embodiment, the information in internal database 172 may use vehicle titles and registrations from the Department of Motor Vehicles (DMV) to create an exact picture of which vehicles reside in specific markets. In the embodiment of FIG. 1, the computing system 100 is coupled to a secured network 161, such as a secured LAN, for example. The system 100 communicates with the internal database 172 through the secured network 161. In some embodiments, the internal database 172 is configured to communicate with additional computing devices over the network 160 or some other network, such as a LAN, WAN, or the Internet via a wired, wireless, or combination of wired and wireless, communication link. In certain embodiments, the client 164 may have access to the internal database 172 through the network 160, and/or the secured network 161 (link not shown).

In the embodiment of FIG. 1, the computing system 100 also includes an aftermarket vehicle part sales performance evaluator module 150 that may be executed by the CPU 105. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

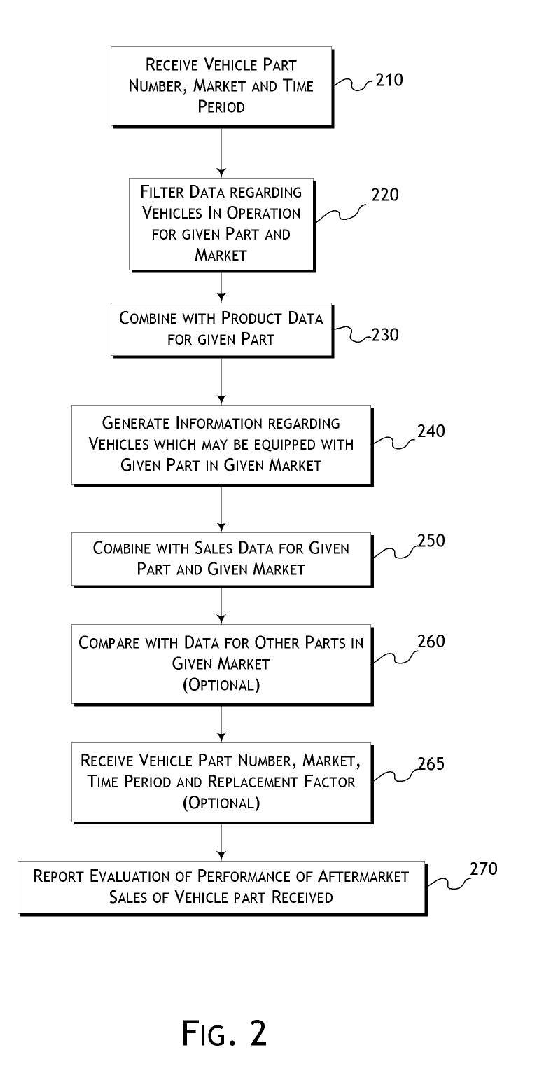

In the embodiment shown in FIG. 1, the computing system 100 is configured to execute aftermarket vehicle part sales performance evaluator module 150, among others, in order to generate various reports associated with aftermarket vehicle part sales information by using data in internal database 172 and/or external database(s) 162 and 166. In some embodiments, the aftermarket vehicle part sales performance evaluator module 150 may be configured to obtain data from internal database 172, from database(s) 162 and/or 166, or from a combination of internal database 172 and database(s) 162 and/or 166. An embodiment of a process for generating reports by performance evaluator module 150 is provided hereafter with reference to FIG. 2. A report may be generated by accessing one ore more of the internal database 172 and external databases 162 and 166 and generating and delivering a report to the client 164 in a format desired by the client, including printed, text file, MS Excel or other similar format deliverables.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It is recognized that the term “remote” may include data, objects, devices, components, and/or modules not stored locally, that is not accessible via the local bus. Thus, remote data may include a device which is physically stored in the same room and connected to the computing system via a network. In other situations, a remote device may also be located in a separate geographic area, such as, for example, in a different location, country, and so forth.

As illustrated in FIG. 1, an embodiment of the disclosed system may obtain product data and/or sales data of a vehicle part for a particular time period and a particular geographic market. This data may be combined with filtered data regarding vehicles in operation in the given market for that time period to perform an aftermarket sales performance evaluation of the vehicle part. In an embodiment, this may be accomplished by the aftermarket vehicle part sales performance evaluator module 150. The aftermarket vehicle part sales performance evaluator module 150 may determine, for example, sales rate, share of total retail product volume, in units and dollars, for a given vehicle part in comparison to the other vehicle parts of a given product line in that geographic market. Method

With an understanding of select embodiments of an aftermarket vehicle part sales performance evaluator system, embodiments of the methods used within these and other configured systems can now be described with reference to FIG. 2. Starting with block 210, the part number associated with a vehicle part is received. Also received are the market and time period of interest. The market is the geographic market of interest. In many embodiments, this is a given zip code/forward sortation area (FSA). It may also be a particular country, state/province, demographic market area (DMA)/census market area (CMA), census tract/postal, block group/dissemination area, or the like. The time period of interest may be a month, a year, and the like.

In the embodiment illustrated, the data regarding vehicles in operation is filtered in block 220 to select data relevant to the given part and market. Thus, the filtering in block 220 generates data regarding, for example, the number of vehicles in operation in the given market with details about the vehicles. Details about the vehicles in operation may include vehicle category, vehicle segmentation, manufacturer, vehicle make, vehicle model, model year, vehicle series, body style, door count, drive wheels, fuel type, engine displacement in liters, engine cylinders, aspiration performance, fuel delivery, wheelbase, vehicle weight, transmission type, AMA compliance codes (ACES and legacy), and the like. The data regarding vehicles in operation is combined with product data for the given part number at block 230. Product data may include information about vehicle part numbers such as the vehicle types which may be equipped with a given vehicle part associated with a part number. Using the combined data regarding vehicles in operation and the product data information, data regarding the number of vehicles in a given market which can be equipped with a given vehicle part is generated in block 240.

At block 250, the data regarding the number of vehicles in a given market which can be equipped with a given vehicle part is combined with sales data for the given market. In one embodiment, sales data may include consumer sales data of aftermarket auto products such as air filters, oil filters, shocks, wiper blades, brakes, etc., gathered and compiled by vehicle part number and geographic region from all major retailers such as AutoZone, PepBoys, NAPA, O'Reilly, etc. By combining the information generated at block 240 with the sales data, statistics about the sales rate of the vehicle part, as well as the share of the potential market, in both unit and dollar amounts may be determined.

In some embodiments, the information generated at block 250 may be compared in block 260 with similar information generated for a different part number. This provides comparative information regarding different parts in the same market.

In some embodiments, at block 265, a vehicle part number, a relevant market, a desired time period and a replacement factor may be received. In some embodiments, replacement factor may be the percentage of vehicles in operation for a given market, and vehicle part which may be the volume of vehicles that are ready for the replacement part due to normal wear and tear.

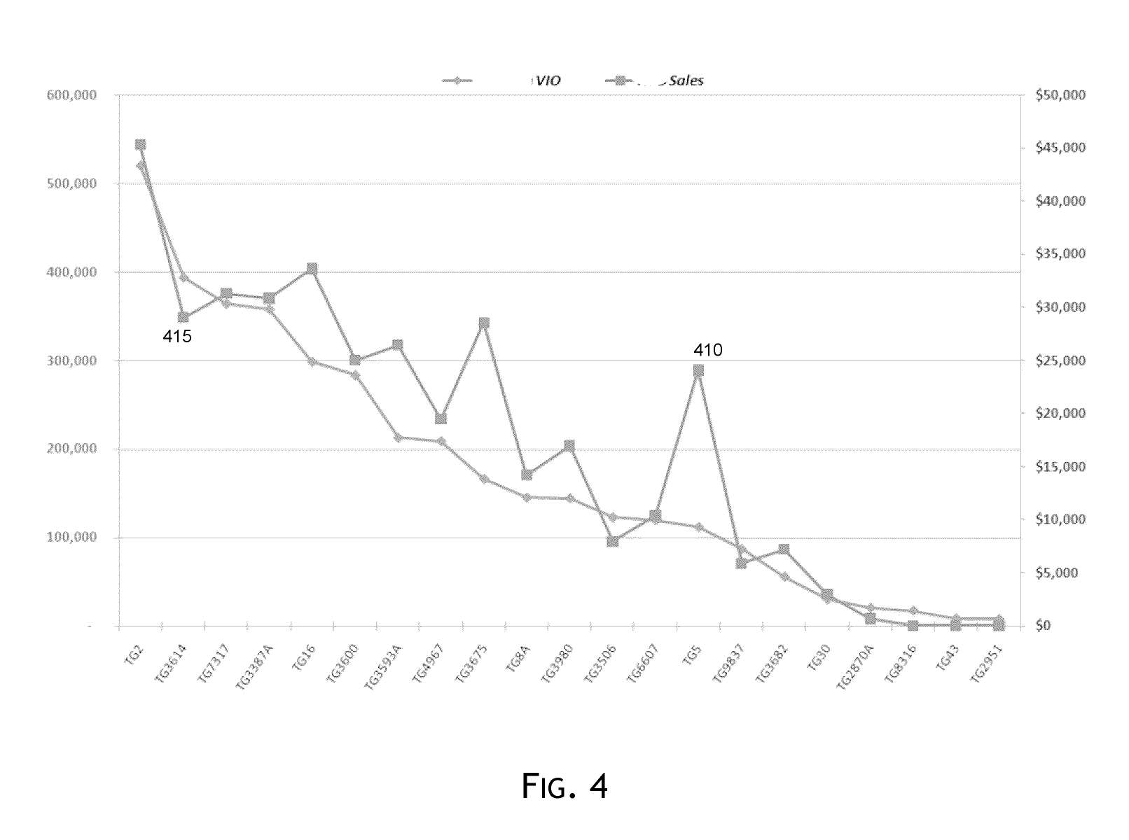

At block 270, the information gathered in blocks 240 and 250 (and in some embodiments, the information gathered in blocks 260 and/or 265) may be organized with respect to a given vehicle part. Also in block 270, a comparison can be made between potential part sales, as represented by vehicles in operation which may be equipped with the given vehicle part, against the actual vehicle part sales for those vehicles within the given geographic market and time period, for analysis purposes. For example, this comparison may be used in determining how the volume of sales of the given vehicle part compares to the volume of vehicles in operation with that same part number across a dual “Y” axis, demonstrating which sales of the given vehicle part for the given market have higher or lower advances over the determined market potential for that period. An example report which may be used to make such a determination is shown in FIG. 4, and described below. The comparison may also be used in determining a volume or percentage of vehicles in operation with the vehicle make and model description that are not assigned parts within the given market area. Such a determination may help identify vehicles which are missing potential part sales from the manufacturer's catalog offering.

Also at block 270, reports may be generated. Data in a report can be formatted to meet user's needs. Multiple formats and delivery options may be available, including delivery of reports via secure FTP. The information generated in the reports provides a basis for making fact-based decisions to better manage vehicle parts portfolio and inventory levels. The reports also provide support for efficiently planning for new vehicle introductions and adjusting for technology changes. In addition, users of the reports may better assess locations for retail stores and service bays.

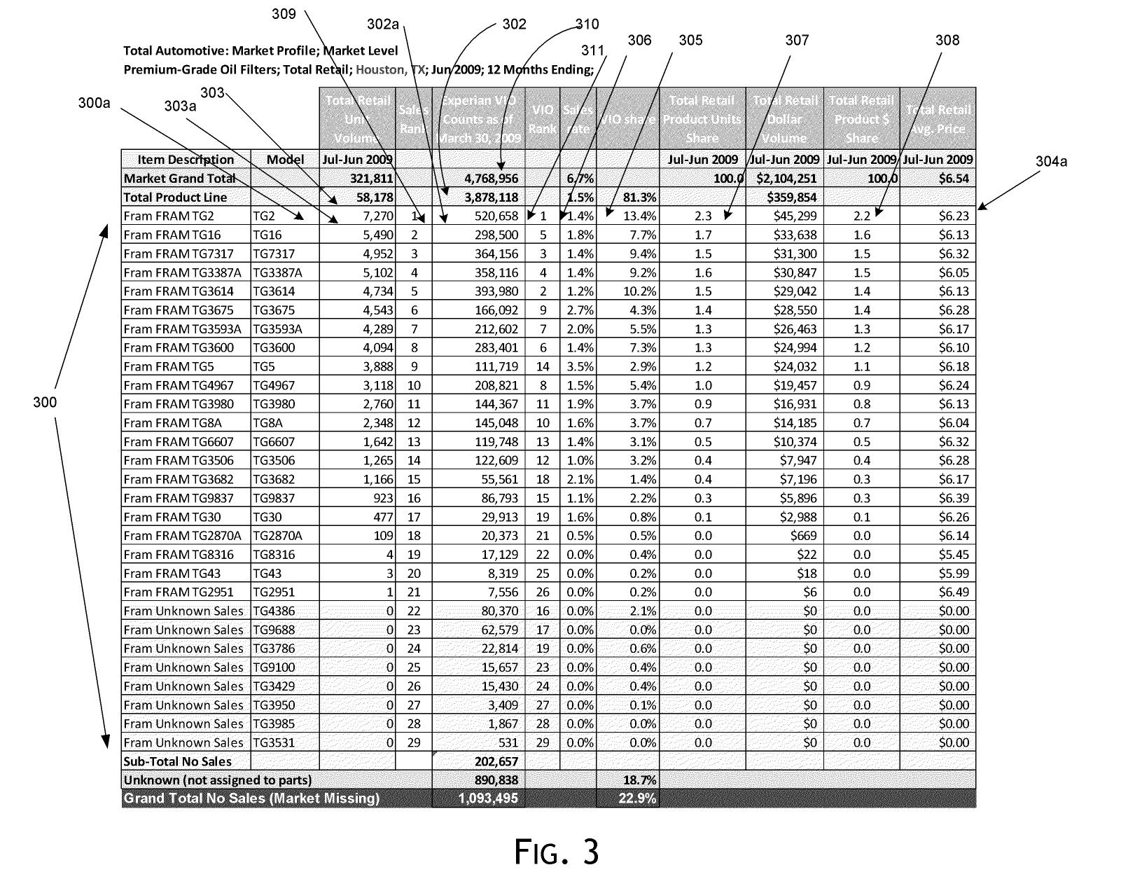

FIG. 3 illustrates an exemplary aftermarket vehicle part sales evaluation report. Excel worksheets, other general or special purpose graphing software, and the like are other potential report formatting options. In the embodiment shown in FIG. 3, the report indicates to the user information regarding all premium-grade oil filters in the geographic market of Houston, Tex. for a period of 12 months ending in June 2009. As indicated by rows 300 in the report, there were 29 different oil filter models that could be sold in that market during that timeframe. Additionally, there were 4,768,956 vehicles in operation (“VIO”) in Houston TX during that timeframe, as indicated by the cell 310, which represents the total number of vehicles in operation as of Mar. 30, 2009, for the whole market of Houston, Texas, regardless of vehicle part. In the example of FIG. 3, cell 302 indicates that only 3,878,118 of the total vehicles in operation could be equipped with the premium-grade oil filters being analyzed, as indicated by the cell 302, which represents the total number of vehicles in operation as of Mar. 30, 2009 in Houston, Tex. which can be equipped with one of the 29 oil filters 300. Of those 3,878,118 vehicles, 58,178 were equipped with a new one of the premium-grade oil filters in the analyzed time period, as indicated by cell 303, representing the total retail volume for the market of 29 oil filter models 300. Given this information, each of the different parts' sales can be analyzed in isolation or in relation to the other parts' sales.

For example, focusing on the Fram TG2 product (300a), the report indicates that:
Average Retail Price: $6.23 (304a)
Total Retail Unit Sales: 7,270 (303a)
Total Number of Vehicles in Operation (“VIO”) in Houston Tex. in this timeframe which can be equipped with a TG2: 520,658 (302a)
Potential to be installed in 13.4% of the vehicles in Houston Tex. which would be equipped with the premium-grade oil filters being analyzed (i.e. 520,658 of 3,878,118) (305)
Sales Rate of 1.4% (i.e. of the 520,658 vehicles which could be equipped with a TG2, 7,270 were actually equipped with one in this time period) (306)
Share of Total Product Unit Volume of 2.3% (i.e. of the 321,811 oil filters sold in Houston Tex. in this time period, 7,270 were TG2s) (307)
Share of Total Product Dollar Volume of 2.2% (i.e. of the $2,104,251 generated by sales of oil filters in Houston Tex. in this time period, $45,299 was generated by the TG2) (308) . In comparison to other parts analyzed, the TG2 ranks first in sales volume (in terms of units sold) (309), and first in ranking of vehicles in operation (in terms of potential to be installed) (311).

FIG. 4 illustrates an exemplary sales performance report. A comparison between potential part sales, as represented by vehicles in operation which may be equipped with the given vehicle part, against the actual vehicle part sales for those vehicles within the given geographic market and time period may be used in determining how the volume of sales of the given vehicle part compares to the volume of vehicles in operation with that same part number. As shown in FIG. 4, a dual “Y” axis may be used to then evaluate which sales of the given vehicle part for the given market have higher or lower performance over the determined market potential for that period. This may be done, for example, by aligning the two axes (volumes of vehicles on the left hand side and sales dollars on the right hand side) and comparing the two axes against each other. Referring to FIG. 4, taking for example the parts TG5 and TG3614 for illustration purposes, point 410 indicates that part TG5 is higher in sales dollars than the volume of vehicles in operation with potential sales for TG5 part and point 415 indicates that TG3614 is lower in sales dollars than the volume of vehicles in operation with potential sales for TG3614 part. This may be an indication that the TG5 has better sales performance than the TG3614.

### Additional Embodiments

All of the processes described above may be embodied in, and fully automated via, software code modules executed by one or more general purpose computers. The code module may be stored in any type of computer-readable medium or other computer storage device. Some or all of the methods may alternatively be embodied in specialized computer hardware. As will be apparent, the features, and attributes of the specific embodiments disclosed above may be combined in different ways to form additional embodiments, all of which are fall within the scope of the present disclosure. Although this disclosure has been described in terms of certain preferred embodiments and applications, other embodiments and applications that are apparent to those of ordinary skill in the art, including embodiments which do not provide all of the features and advantages set forth herein, are also within the scope of this disclosure.

What is claimed is:

1. A method of evaluating the aftermarket performance of vehicle part sales, performed by a computer system having a processor that supports operation of a software application, the method comprising:
receiving a vehicle part identifier associated with a vehicle part to be evaluated;
receiving information related to vehicles in operation in a given market;
receiving product information related to the vehicle part;
receiving sales information related to the vehicle part in the given market;
processing, in the processor, the information related to vehicles in operation in a given market, the product information related to the vehicle part and the sales information related to the vehicle part to produce an evaluation of the aftermarket performance of the vehicle part sales; and
generating an evaluation report of the aftermarket performance of the vehicle part sales.

2. The method of claim 1 wherein the vehicle part identifier is received from a user and the method further comprises the step of sending the evaluation report of the aftermarket performance to the user.

3. The method of claim 1 wherein the given market is a geographic area.

4. The method of claim 1 wherein the given market is the market associated with a vehicle type.

5. The method of claim 1 wherein the given market is the market associated with a vehicle age.

6. The method of claim 1 wherein product information related to the vehicle part comprises a designation of vehicle part identifiers and a designation of vehicles in which each of the parts can be installed.

7. The method of claim 1 wherein sales information related to the vehicle part comprises the number of parts sold.

8. The method of claim 1 wherein the receiving, gathering, combining, and generating are repeated at intervals.

9. The method of claim 1, wherein the evaluation of the aftermarket performance comprises a comparison of the sales of the vehicle part in relation to the vehicles in operation.

10. The method of claim 1, wherein the evaluation of the aftermarket performance comprises an indication of the share of the sales rate of the vehicle part.

11. The method of claim 2, wherein the user is one of:
a vehicle parts manufacturer;
a vehicle parts retailer;
a vehicle insurance provider; or a lender.

12. A system for evaluating the aftermarket performance of vehicle part sales, comprising:
a computer system having a processor that supports operation of a software application;
a data storage module, in communication with the computer system, the data storage module including information about vehicles in operation in a given market, product information related to the vehicle part and sales information related to the vehicle part in the given market;
an aftermarket vehicle part sales evaluation module configured to evaluate the aftermarket sales performance of the plurality of vehicle part data records; and
an output module configured to report the vehicle part sales evaluation to a user;
wherein the computer system is configured to accept a vehicle part identifier and to communicate the vehicle part identifier to the aftermarket vehicle part sales evaluation module, and wherein the aftermarket vehicle part sales evaluation module bases its evaluation of aftermarket vehicle part sales on at least the vehicle part identifier, the information about vehicles in operation in a given market, the product information related to the vehicle part and the sales information related to the vehicle part in the given market.

13. A non-transitory computer readable medium having computer executable instructions that direct a computing system to:
receive a vehicle part identifier associated with a vehicle part to be evaluated;
receive information related to vehicles in operation in a given market;
receive product information related to the vehicle part;
receive sales information related to the vehicle part in the given market;
process the information related to vehicles in operation in a given market, the product information related to the vehicle part and the sales information related to the vehicle part to produce an evaluation of the aftermarket performance of the vehicle part sales; and
generate an evaluation report of the aftermarket performance of the vehicle part sales.

14. A system for evaluating the aftermarket performance of vehicle part sales comprising:
means for receiving a vehicle part identifier associated with a vehicle part to be evaluated;
means for receiving information related to vehicles in operation in a given market;
means for receiving product information related to the vehicle part;
means for receiving sales information related to the vehicle part in the given market;
means for processing the information related to vehicles in operation in a given market, the product information related to the vehicle part and the sales information related to the vehicle part to produce an evaluation of the aftermarket performance of the vehicle part sales; and
means for generating an evaluation report of the aftermarket performance of the vehicle part sales.
